(19) United States
(12) Patent Application Publication
(10) Pub. No.: US 2026/0039116 A1
(43) Pub. Date: Feb. 5, 2026

(54) ELECTRIC VEHICLE STATUS DARK START CHARGE

(71) Applicant: FORD GLOBAL TECHNOLOGIES, LLC, Dearborn, MI (US)

(72) Inventors: Zdravko Nikolik, Tecumseh (CA); Patrick Soderborg, Dexter, MI (US); Mukta Darekar, Dearborn, MI (US); Kevin Stinnette, Monroe, MI (US); Richard Mo, Canton, MI (US); Timothy Harris, Grosse Ile, MI (US)

(21) Appl. No.: 18/790,283

(22) Filed: Jul. 31, 2024

(51) Int. Cl. H02J 3/32; B60L 53/62; B60L 58/12; H02J 7/34

(52) U.S. Cl. CPC H02J 3/322; B60L 53/62; B60L 58/12; H02J 7/342; B60L 2250/14

(57) ABSTRACT

A home energy system includes a combiner box with a power source and a microprocessor. The microprocessor maintains a first target state of charge for the power source using power from a traction battery of an electric vehicle when the vehicle is powering a home. When the system detects that the vehicle will stop powering the home, the microprocessor charges the power source from the traction battery to reach a second target state of charge.

### TECHNICAL FIELD

This disclosure relates to power management.

### BACKGROUND

An electric vehicle may be one of several power sources that provides backup power to a home when the grid becomes unavailable.

### SUMMARY

A home energy system includes a combiner box equipped with a power source and a microprocessor. The microprocessor is programmed to maintain a first target state of charge for the power source using power from the traction battery of an electric vehicle, as long as the vehicle is powering the home. If there is an indication that the vehicle will stop powering the home, the microprocessor will then charge the power source from the traction battery until it reaches a second target state of charge.

A method involves increasing the state of charge of a combiner box battery, which is electrically connected to the traction battery of an electric vehicle via electric vehicle supply equipment, using power from the traction battery when it is indicated that the vehicle will be departing and will no longer power the home.

A combiner box includes a battery designed to provide power to start a home energy system, which includes the combiner box itself, and is electrically connected to the traction battery of an electric vehicle via electric vehicle supply equipment. The combiner box also features a microprocessor programmed to respond to an indication that the state of charge of the traction battery, while powering the home, will fall below a threshold value by increasing the state of charge of the combiner box battery using power from the traction battery.

### BRIEF DESCRIPTION OF THE DRAWINGS

FIG. 1 is a schematic diagram of a home energy system.

FIG. 2 is a schematic diagram of portions of the home energy system of FIG. 1.

FIG. 3 is a flowchart of an algorithm for managing a state of charge of a combiner box battery.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In the context of an electric vehicle (EV) powered home backup system, the backup (or dark start) battery plays a role in maintaining system functionality when the EV is not present. The combiner box manages the distribution of AC power from various sources, such as the grid, solar panels, stationary batteries, and generators, to the home. During grid outages, the combiner box isolates the home from the grid and manages the flow of backup power. The dark start battery (e.g., a 12V battery) ensures that the combiner box and electric vehicle supply equipment (EVSE) remain operational when the EV, a source of power, is away.

Management of the dark start battery state of charge (SOC) assists in balancing longevity and standby time. Longevity refers to the battery's lifespan or time-in-service, while standby time is the duration the battery can support the system in the absence of the EV. Achieving this balance can be challenging because an optimal SOC for longevity (e.g., 50%, 60%) may differ from an optimal SOC for maximum standby time (e.g., 90, 100%).

A proposed system may continuously monitor the EV's SOC. When the EV SOC drops below a predefined threshold, indicating that the EV's ability to power the home is at issue, the system may shift its focus to increasing the dark start battery standby time. This may involve charging the dark start battery to a higher SOC with power from the EV to ensure it can support the system until the EV is recharged and returns.

Users can notify the system of their planned EV departure through mobile applications and the like. The system may also utilize stored user schedules to anticipate EV absences. This proactive approach allows the system to adjust the dark start battery SOC accordingly. For instance, if a user indicates a prolonged absence, the system might reduce the SOC target below 100% to balance longevity with the anticipated standby duration. In the absence of imminent threats, the system may target an SOC, for example, of around 50% to prolong the battery's life. This adaptive strategy results in the battery not being kept at full charge unnecessarily, which may accelerate degradation and reduce its overall state of health (SOH). The system may dynamically adjust the SOC target based on real-time data, user inputs, and anticipated needs.

The integration of these elements into the home backup system involves control logic. The combiner box communicates with the EVSE to manage power distribution. During an EV home backup event, the system facilitates transition and coordination between different power sources. It may leverage cloud connectivity to access user schedules and other relevant data, enabling predictive adjustments to the dark start battery SOC. An application may serve as a user interface, allowing users to provide input regarding their EV usage plans, which is helpful for enabling the system to make informed decisions about SOC management.

Combiner boxes, in more detail, are components in some home backup energy systems that incorporate a variety of energy sources, such as solar panels, wind turbines, generators, and vehicle-to-grid systems. These boxes function primarily to aggregate outputs from these multiple energy-generating sources into a single electrical output. This consolidated output can then be channeled into an inverter or a central controller, simplifying the management of various inputs.

Combiner boxes can be equipped with several components including overcurrent protection devices such as fuses or circuit breakers that shield the wiring and other components from potential over currents due to faults or mismatches in panel outputs. Additionally, surge protection devices within these boxes help guard against voltage spikes that are often caused by lightning strikes or disruptions in the grid. Disconnect switches are also included to allow for the manual disconnection of energy sources for system maintenance or other checks. Moreover, modern combiner boxes may incorporate voltage and current sensors on each input to facilitate the monitoring and optimization of performance for each energy source, aiding in fault diagnosis and system management.

Combiner boxes control AC power flow from multiple AC sources, such as photovoltaic inverters, EVs, and stationary battery inverters, to one AC bus that can be tapped or sourced by AC loads including a home, high voltage energy storage devices, or the grid.

When integrated into home energy systems, combiner boxes enable the output from solar panels or other energy sources to be aggregated for use in home appliances, battery storage, or feeding back into the grid. An external inverter, which may be separate from the combiner box, is for managing the energy flow to and from the battery storage system. Combiner aggregation allows for energy storage during low usage periods and its utilization during peak demand or low generation times. Combiner boxes also facilitate the integration of generators and vehicle-to-grid systems as supplementary inputs, possibly optimizing the energy usage based on availability or economic considerations, such as using stored battery power during peak grid prices.

Systems equipped with grid-tied inverters can send excess power back to the public grid, generating credits or revenue for homeowners. These systems can also participate in demand response services, helping to stabilize the grid by adjusting their energy consumption or supplying stored energy during peak periods. Enhanced by Internet of Things technology, modern combiner boxes can be integrated into larger energy management systems that optimize home energy usage. Homeowners can monitor their energy systems in real-time through smartphone applications or computer software, assessing everything from the output of individual solar panels to the status of batteries and the overall efficiency of the system.

A switch mode power supply (SMPS), often included in combiner boxes, is a power conversion device. Unlike traditional linear power supplies that dissipate excess voltage as heat to control output, SMPSs switch on and off rapidly to control the amount of energy delivered to the load, thereby minimizing energy loss. This switching action is managed by a semiconductor device, typically a transistor, which alternates between low and high impedance states, effectively controlling the voltage and current delivered to the load.

The operation of an SMPS may involve several stages. The AC mains voltage is first rectified to produce a high-voltage DC, which is then converted to a high-frequency AC through the switching action of the transistor. This high-frequency AC is then transformed to the desired voltage level using a small transformer. After transformation, the AC is rectified again to produce a stable DC output. The output voltage is controlled by adjusting the duty cycle of the switching transistor, which is the proportion of time that the transistor is conducting versus the time it is off. This control is achieved through feedback mechanisms that continuously monitor the output and adjust the switching accordingly to maintain a constant output voltage regardless of changes in input voltage or load conditions.

SMPSs can accommodate a wide range of input voltages. The relatively fast response time of SMPSs to changing load conditions and their ability to provide features such as overvoltage protection, current limiting, and thermal shutdown further contribute to their robustness.

The function of EVSE is not merely to supply electricity but to communicate with the EV to coordinate the charging process. This may involve a communication protocol that confirms the electrical connection's integrity, identifies the maximum current capacity of the EV's onboard charger, and ensures that the vehicle is properly connected and ready to receive power before charging begins. The EVSE can manage the power delivery to the vehicle, modulating current flow and monitoring the connection for faults or sudden disconnects.

EVSE varies in terms of the charging levels it offers, which are categorized mainly into three levels based on the power output and the charging speed. Level 1 charging is the slowest form, using a standard 120-volt AC outlet commonly found in home settings. It delivers around 1.4 kW of power and is typically used for overnight charging, providing roughly 4 to 5 miles of range per hour of charging. Level 2 charging uses a 240-volt AC supply, similar to what large household appliances use. It significantly increases charging speed, offering about 15 to 70 miles of range per hour of charging with power outputs ranging from 3 kW to 22 kW. The fastest type, Level 3, also known as DC fast charging, uses a direct current (DC) supply of up to 400 volts or more, providing power levels upwards of 50 kW and up to 350 kW in some installations. This can charge an EV battery to 80% capacity in as little as 20 minutes.

Some EVSE have features that integrate into smart grid technology, offering functionalities like scheduled charging during off-peak electricity rate periods, remote control and monitoring via smartphone applications, and integration with home energy management systems. This smart connectivity may support grid stability by allowing EVs to function as grid resources. In vehicle-to-grid setups, EVs can return energy to the grid, helping to balance supply and demand dynamics.

Features in some EVSE may include ground fault circuit interrupter protection and connectivity checks that ensure the charger is communicating with the vehicle before and during the charging process.

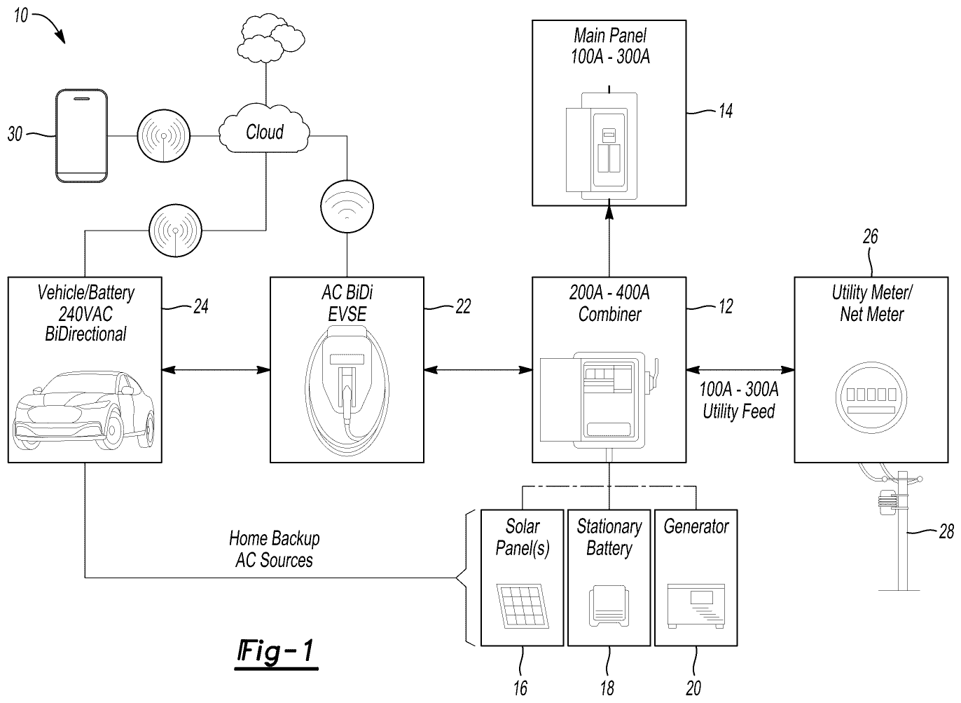

Referring to FIG. 1, an example home energy system 10 includes a combiner box 12, a main panel 14, which is associated with a home, solar panels 16, a stationary battery 18, a generator 20, EVSE 22, and an EV 24, which includes a traction battery and bidirectional power capabilities. The combiner box 12 is connected with a utility meter 26 of a grid 28 and connected between the main panel 14 and the solar panels 16, stationary battery 18, and generator 20. The combiner box 12 may also be connected with the EV 24 via the EVSE 22. In this arrangement, the solar panels 16, stationary battery 18, generator 20, and EV 24 are backup sources for the home. The EVSE 22 and EV 24 may be in communication with a mobile device 30 (e.g., cell phone) via cloud services, etc. When the grid 28 becomes unavailable, the combiner box 12 isolates from the grid 28, communicates with the backup sources for the home, and controls AC power flow to back up the home.

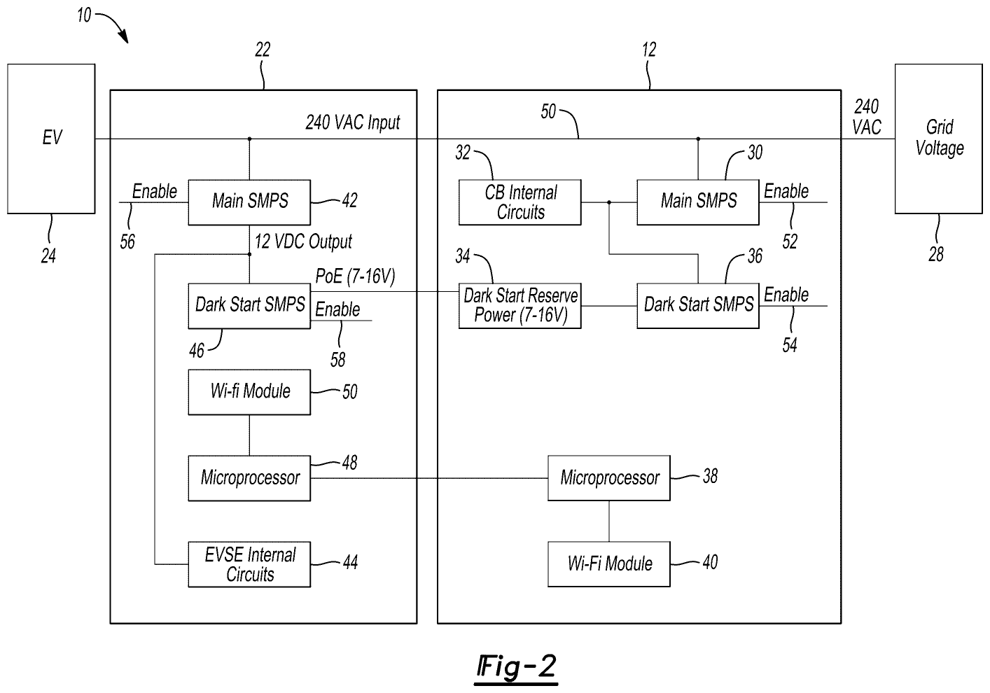

Referring to FIG. 2, the combiner box 12 includes a main SMPS 30, internal circuits 32, a reserve (or dark start) power source 34 (e.g., a 12V dark start battery, etc.), a reserve (or dark start) SMPS 36, a controller including a microprocessor 38, and a communications module 40 (e.g., a Wi-Fi module, etc.). The EVSE 22 includes a main SMPS 42, internal circuits 44, a reserve (or dark start) SMPS 46, a controller including a microprocessor 48, and a communications module 50 (e.g., a Wi-Fi module etc.). The reserve power source 34 aids in the process of starting up certain components of the home energy system 10 when power from the grid 28 is unavailable. It, for example, powers components of the combiner box 12 and EVSE 22 when the electric vehicle 24 is not present while the grid 28 is unavailable.

When the EVSE 22 is electrically connected with the combiner box 12 and electric vehicle 24, a continuous AC line 50 is established between the EV 24 (its traction battery) and grid 28. The main SMPS 30 is electrically connected with the AC line 50. The main SMPS 30, internal circuits 32, and reserve SMPS 36 are electrically connected together. And the reserve power source 34 and reserve SMPS 36 are electrically connected together. The microprocessor 38 is in communication with the communications module 40 and may exert control over components of the combiner box 12 via, for example, the enable lines 52, 54 associated with the main SMPS 30 and reserve SMPS 36, respectively.

The main SMPS 42 is electrically connected with the AC line 50. The main SMPS 42, internal circuits 44, and reserve SMPS 46 are electrically connected together. The microprocessor 48 is in communication with the communications module 50 and may exert control over components of the EVSE 22 via, for example, the enable lines 56, 58 associated with the main SMPS 42 and reserve SMPS 46, respectively.

The reserve power source 34 and reserve SMPS 46 are connected via an Ethernet connection such that PoE energy transfer occurs between the two. Moreover, the microprocessors 38, 48 are connected via a communication link.

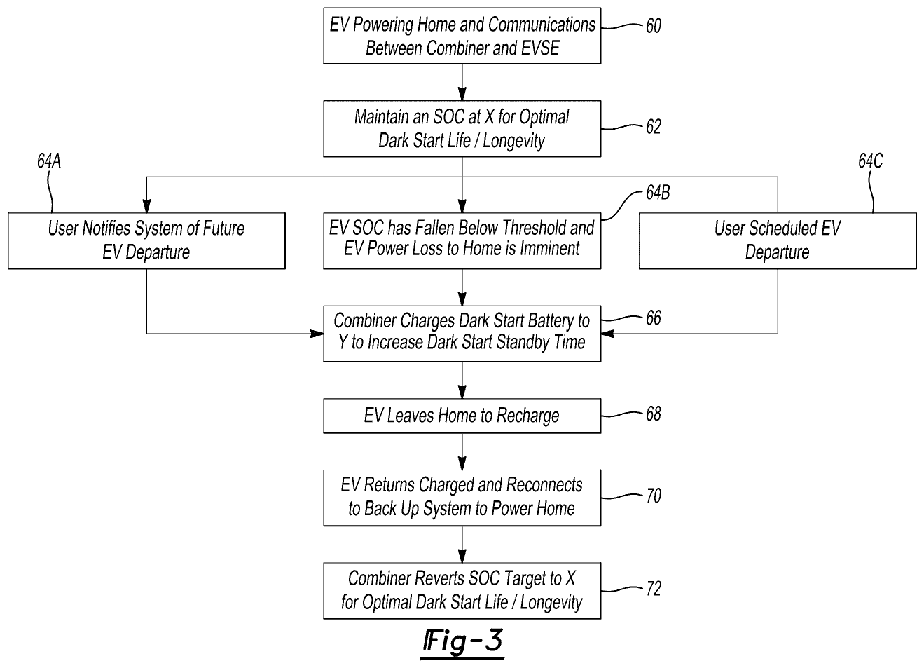

Referring to FIG. 3, the process begins with operation 60, which denotes an entry condition where the EV 24 is powering the home and there is communication between the combiner box 12 and the EVSE 22. This setup ensures that the system is actively managing the power distribution and monitoring the SOC of both the EV 24 and the power source 34 via known sensors, etc.

Operation 62 involves the system maintaining the dark start battery SOC at a target value for optimal value life/longevity.

At operation 64A, a user notifies the system of a future EV departure. At operation 64B, the system detects that the EV SOC has fallen below a predefined threshold (e.g., 40%, 50%), indicating that power loss to the home is imminent. At operation 64C, a user schedules an EV departure. The threshold of operation 64A and indicators of operations 64B, 64C act as triggers for the system to initiate measures to preserve home power.

Operation 66 involves the system responding to any of the operations 64A, 64B, 64C by charging the power source 34 to a higher target SOC. This increases the standby time of the power source 34, allowing it to support the system during absence or unavailability of the EV 24.

At operation 68, the EV 24 leaves the home to recharge.

Operation 70 occurs when the EV 24 returns home charged and reconnects to the backup system to resume powering the home. This step marks the transition back to using the EV 24 as the primary power source.

At operation 72, the system can reset the dark start battery SOC to that associated with operation 62, allowing it to decrease. This avoids always targeting a high target SOC (e.g., 100), which may lead to faster degradation of the battery's state of health.

Throughout these steps, the system dynamically adjusts the SOC targets based on real-time data, user inputs, and anticipated needs to balance needs of the dark start battery in terms of longevity and standby time. By monitoring the EV's SOC, incorporating user inputs, and leveraging cloud connectivity, the system can dynamically adjust the SOC.

The algorithms, methods, or processes disclosed herein can be deliverable to or implemented by a computer, controller, or processing device, such as the microprocessors 38, 48, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Microprocessor” and “Microprocessors,” for example, can be used interchangeably herein as the functionality of one can be distributed across several, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A home energy system comprising:
a combiner box including a power source and a microprocessor, the microprocessor programmed to, provided a traction battery of an electric vehicle is powering a home, maintain a first target state of charge for the power source with power from the traction battery and responsive to indication that the powering will discontinue, charge the power source with power from the traction battery such that a state of charge of the power source increases to a second target state of charge.

2. The home energy system of claim 1, wherein the indication is a user notification.

3. The home energy system of claim 1, wherein the indication is a scheduled departure of the electric vehicle.

4. The home energy system of claim 1, wherein the indication is a state of charge of the traction battery falling below a threshold value.

5. The home energy system of claim 1, wherein the power source is a battery.

6. The home energy system of claim 1, wherein the microprocessor is further programmed to, after the powering has been discontinued and the electric vehicle has returned following a departure, revert to the first target state of charge target.

7. The home energy system of claim 1, wherein the combiner box is configured to be electrically connected with the traction battery via electric vehicle supply equipment.

8. A method comprising:
responsive to indication that an electric vehicle, having a traction battery powering a home, will be departing, increasing a state of charge of a combiner box battery electrically connected with the traction battery via electric vehicle supply equipment with power from the traction battery.

9. The method of claim 8 further comprising, responsive to return of the electric vehicle and resumption of the powering, decreasing a target state of charge of the combiner box battery.

10. The method of claim 8 further comprising, responsive to indication that a state of charge of the traction battery will fall below a threshold value, increasing the state of charge of the combiner box battery with power from the traction battery.

11. The method of claim 8, wherein the indication is associated with a user notification or a scheduled departure time.

12. A combiner box comprising:
a battery configured to provide power to start a home energy system that includes the combiner box and be electrically connected with a traction battery of an electric vehicle via electric vehicle supply equipment; and
a microprocessor programmed to, responsive to indication that a state of charge of the traction battery, when powering a home, will fall below a threshold value, increase a state of charge of the battery with power from the traction battery.

13. The combiner box of claim 12, wherein the microprocessor is further programmed to, responsive to indication that the electric vehicle will be departing, increase the state of charge of the battery with power from the traction battery.

14. The combiner box of claim 13, wherein the indication is a user notification.

15. The combiner box of claim 13, wherein the indication is a scheduled departure of the electric vehicle.

16. The combiner box of claim 12, wherein the battery is a 12V battery.

17. The combiner box of claim 12, wherein the microprocessor is further programmed to decrease the state of charge of the battery.
